(19) United States
(12) Patent Application Publication
(10) Pub. No.: US 2010/0066603 A1
(43) Pub. Date: Mar. 18, 2010

(54) System and Methods for Real Time Kinematic Surveying Using GNSS and Ultra Wideband Ranging

(76) Inventors: Kyle O'Keefe, Calgary (CA); Glenn MacGougan, Calgary (CA); David Chiu, Calgary (CA)

Correspondence Address: FULBRIGHT & JAWORSKI L.L.P., 600 CONGRESS AVE., SUITE 2400, AUSTIN, TX, 78701, US

(21) Appl. No.: 12/560,319

(22) Filed: Sep. 15, 2009

Related U.S. Application Data
(60) Provisional application No. 61/096,962, filed on Sep. 15, 2008.

(51) Int. Cl. G01S 19/45; G01S 5/14

(52) U.S. Cl. 342/357.02; 342/357.14

(57) ABSTRACT

Disclosed are systems and methods for augmenting the GNSS RTK surveying system with ground-based ranging transceivers, such as ultra wideband (UWB) Radio Frequency (RF) transceivers. A system embodiment includes a plurality UWB reference ranging transceivers, a movable UWB ranging transceiver, and at least one GNSS RTK receiver. A method includes identifying the surveyed area and placing one or more reference ranging transceivers in the locations proximate to the identified surveyed area. A position of such reference ranging transceivers may be determined using a GNSS receiver. A movable ranging transceiver may be provided in the surveyed area which is configured conduct ranging measurements. GNSS satellite measurements and UWB ranging measurements may be combined to estimate the position of the surveying ranging transceiver. An estimate for the bias and scale factor states for UWB range pairs may be undertaken in order to provide improved position estimation.

### CROSS-REFERENCE TO RELATED APPLICATIONS

This application claims the benefit of U.S. Provisional Application No. 61/096,962 filed Sep. 15, 2008, the entire contents of which is specifically incorporated herein by reference without disclaimer.

### BACKGROUND OF THE INVENTION

1. Field of the Invention

The present disclosure relates generally to the field of surveying and, more specifically, to real time kinematic (RTK) survey systems which utilize global navigation satellite systems (GNSS) augmented with ultra wideband (UWB) ranging.

2. Description of the Related Art

Land surveying is the technique of accurately determining the three-dimensional space position of points and the distances and angles between them. Surveying is typically used in transport, building and construction, communications, mapping, the definition of legal boundaries and other applications. Surveying techniques have evolved with advances in sciences and technology. Currently, the most popular and accurate surveying techniques use satellite navigation signals in position determination. In particular, real time kinematic (RTK) positioning using global navigation satellite systems (GNSS), such as GPS, GLONASS, and Galileo, has been noted to provide centimeter-level accuracies under nominal signal conditions.

However, satellite-assisted surveying systems are limited in application because they require an unobstructed line-of-sight (LOS) signal propagation between the satellite and the ground-based receiver. For example, RTK, alone, is often not sufficient in estimating a position solution when the receiver lacks a clear view of at least four satellites, most commercial systems will not operate unless at least five satellites are in view. One approach to solve this problem is to employ a GNSS receiver that is capable of tracking satellites from multiple satellite systems, such as GPS, GLONASS and others. By doing this, the range of GNSS can be extended into moderate urban canyons, but it is still limited by the requirement for a good view of the sky.

Another problem with GNSS RTK is that the systems are affected by signal masking, attenuation, multipath and other propagation impairments in urban canyons, forests, congested construction sites and other hostile environments where surveying is typically conducted. Because of the poor signal conditions, the surveyors are forced to use the traditional optical surveying equipment and other time consuming methods to supplement the RTK measurements. Hence, in order to use GNSS RTK and maintain centimeter-level accuracies consistently, a new method to augment the system under sub-optimal signal conditions is desirable.

### SUMMARY OF THE INVENTION

Disclosed are systems and methods for augmenting the GNSS RTK surveying system with ground-based ranging transceivers, such as ultra wideband (UWB) Radio Frequency (RF) transceivers. In one example embodiment, the surveying system includes a plurality UWB reference ranging transceivers, a movable UWB survey ranging transceiver, and at least one GNSS RTK receiver. A surveying method includes identifying the surveyed area and placing one or more reference ranging transceivers in the locations proximate to the identified surveyed area where GNSS signals are detected. A position of one or more reference ranging transceivers may be determined using a GNSS receiver. A movable survey ranging transceiver may also be provided in the surveyed area which is configured conduct ranging measurements. In some embodiments the surveyed area may be an area with limited GNSS signal availability. UWB ranging measurements may then be conducted between a plurality UWB ranging transceiver pairs including between reference transceivers and between the survey ranging transceiver and the reference transceivers. And GNSS satellite measurements and UWB ranging measurements may be combined to estimate the position of the surveying ranging transceiver. In some embodiments an estimate for the bias and scale factor states for UWB range pairs is undertaken in order to provide an improved position estimation.

In a further embodiment, the surveying method may include placing one or more reference ranging transceivers in one or more known locations proximate to the identified survey area, providing coordinates of the known position of at least one of said reference ranging transceivers, providing a survey ranging transceiver in the survey area, said survey ranging transceiver configured to conduct ranging measurements, conducting ranging measurements between said survey ranging transceiver and at least one of said reference transceivers, and combining the known coordinates and ranging measurements to estimate the position of the surveying ranging transceiver.

The disclosed GNSS RTK surveying system with UWB ranging provides a number of benefits in surveying applications. First, unlike GNSS systems, the UWB radios do not require line of sight propagation between the UWB transceivers, thereby allowing surveying of areas which do not have GNSS signal reception, such as urban canyons, forests, congested construction sites. Second, UWB provides fine ranging precision and robust performance in high multipath environments and thus enables a GNSS RTK positioning system to operate in more hostile conditions. Third, frequency selective fading from materials, which is a common problem for GNSS signals, is also mitigated since UWB's power is spread over a very large bandwidth. Other advantages of the UWB ranging system will be apparent to those of skill in the art.

### BRIEF DESCRIPTION OF THE DRAWINGS

The invention may be best understood by referring to the following description and accompanying drawings that are used to illustrate embodiments of the invention.

In the drawings:

FIG. 1A is a diagram of the surveying system in accordance with one example embodiment;

FIG. 1B is a block diagram illustrating a surveying system in accordance with another example embodiment;

FIG. 2A is a diagram of the surveying system in accordance with one example embodiment;

FIG. 2B is a diagram of the surveying system in accordance with another example embodiment;

FIG. 2C is a photograph of a positioning apparatus according to one example embodiment of the surveying system;

FIG. 2D is a diagram of a UWB reference station deployed over a known point in accordance with on example embodiment of the surveying system;

FIG. 3A illustrates a flow diagram of one example embodiment of a surveying process;

FIG. 3B illustrates a flow diagram of another example embodiment of a surveying process;

FIG. 4 is a diagram of one example embodiment of a data processing system;

FIG. 5 illustrates asynchronous ranging via two-way time-of-flight measurements; and

FIG. 6 is a table of exemplary UWB ranging errors (two-way time-of-flight technique).

### DETAILED DESCRIPTION OF EXAMPLE EMBODIMENTS

Those of ordinary skill in the art will realize that the following detailed description of the present invention is illustrative only and is not intended to be in any way limiting. Other embodiments of the present invention will readily suggest themselves to such skilled persons having the benefit of this disclosure. It will be apparent to one skilled in the art that these specific details may not be required to practice the present invention. In other instances, well-known computing systems, electric circuits and various data collection devices are shown in block diagram form to avoid obscuring the present invention. In the following description of the embodiments, substantially the same parts are denoted by the same reference numerals.

In the interest of clarity, not all of the features of the implementations described herein are shown and described. It will, of course, be appreciated that in the development of any such actual implementation, numerous implementation-specific devices must be made in order to achieve the developer's specific goals, wherein these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

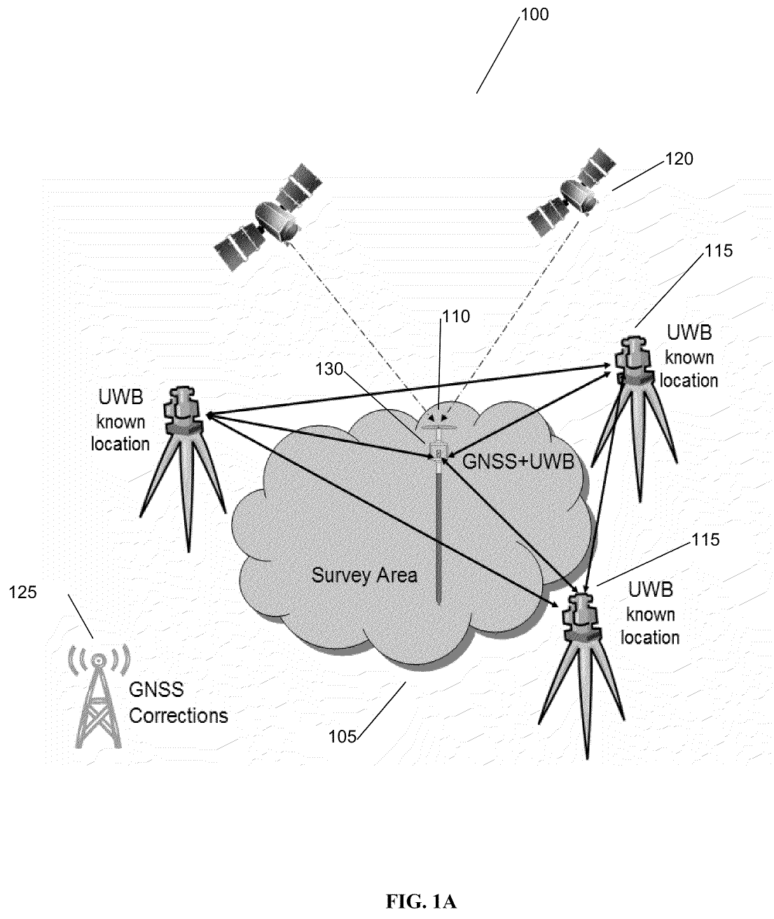

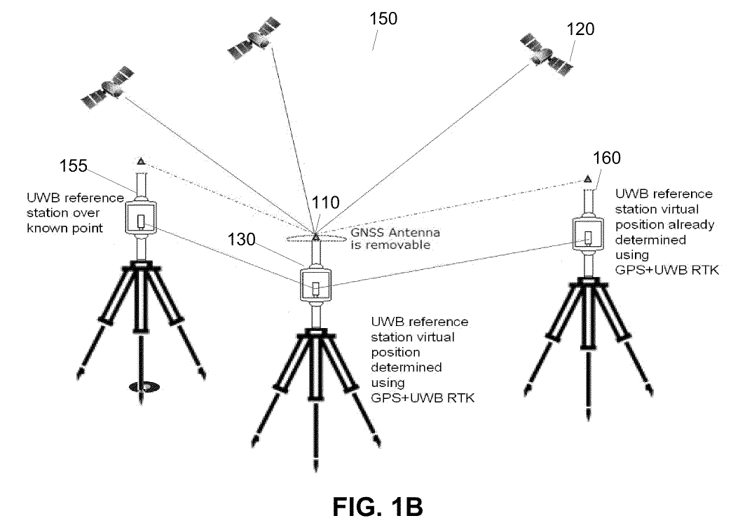

Disclosed are systems and methods for augmenting the GNSS RTK surveying system with ground-based ranging transceivers, such as ultra wideband (UWB) Radio Frequency (RF) transceivers. FIG. 1A depicts one example embodiment of the surveying system 100 for surveying area 105. System 100 may include a ground-based GNSS receiver 110 capable of detecting signals from GPS, GLONASS, Galileo or other orbiting satellites 120. Generally, the GNSS receiver 110 needs to see at least four orbiting satellites 120 to determine its position. In one example embodiment, GNSS receiver 110 is configured to provide RTK positioning, which is based on the use of carrier phase measurements. Generally, satellite navigation receivers compare a pseudorandom signal being sent from the satellite with an internally generated copy of the same signal. Since the signal from the satellite takes time to reach the receiver, the two signals do not “line up” properly. The satellite's copy is delayed in relation to the local copy. By progressively delaying the local copy more and more, the two signals will eventually line up properly. That delay is the time needed for the signal to reach the receiver, and from this the distance from the satellite can be calculated. The accuracy of the resulting range measurement is generally a function of the ability of the receiver's electronics to accurately compare the two signals. In general GNSS receivers are able to align the signals to about 1% of one code chip of the pseudorandom sequence. This delay is called a pseudorange due to the fact that it is biased by the unknown receiver clock offset. GNSS RTK follows the same general concept, but uses the satellite's carrier as its signal, not the messages contained within. The improvement possible using this signal is very high since about 1% accuracy in phase tracking is achieved when phase locked. For a signal with a wavelength of approximately 19 cm, this corresponds to 1.9 mm. In addition to pseudoranges and carrier phases (also known as accumulated Doppler range, GNSS measurements, may include, but are not limited to, Doppler, decoded navigation data, carrier to noise density ratio and other measurements.

In one example embodiment, the GNSS RTK system 100 further includes a plurality of ranging transceivers 115, such as ultra wideband (UWB) radios. UWB is a radio technology typically used at very low energy levels (maximum of −41 dBm/MHz) for short-range high-bandwidth communications by using a large portion of the radio spectrum (bandwidth of 7.5 GHz). In one example embodiment, UWB may be defined as signals with a 10-dB fractional bandwidth larger than 0.20, or a 10-dB bandwidth equal to or larger than 500 MHz. UWB may be particularly useful in situations where there is a low data rate and/or very low power, such as for low cost ranging sensor networks and the like. The precision of ranging measurements by means of timing using modulated RF signals is a function of the received signal to noise ratio (SNR) and the bandwidth of the signal employed. Hence, increasing signal bandwidth is an excellent means of improving measurement precision. UWB offers centimeter to decimeter level precision range measurements. Moreover, UWB has many other advantages including signal robustness (to interference), high communications capacity (e.g. 400 Mbps), resistance to frequency selective fading (i.e. multipath), and fine time resolution (e.g. cm level). For this reason, the UWB technology may be used to augment high precision surveying equipment such as GNSS RTK system 110.

In another embodiment, as described in FIG. 1B, the UWB reference stations may be deployed at unknown locations using a method that gains from other UWB reference stations 155, 160 that have already been deployed. This method may only require a single GNSS receiver 110 (in addition to the GNSS system used to provide differential GNSS corrections). Once suitable locations are selected, the UWB reference stations 155, 160 may be set up (e.g. on tripods). The station with the best GNSS satellite visibility conditions is surveyed first. The GNSS receiver 110 is mounted over the first station's UWB antenna and an RTK position may be determined. If UWB reference stations located on previously surveyed points are set up, the tightly-coupled RTK solution may be used. The range measurement obtained from the UWB reference station 155 to the reference station under survey may be biased. Typically in-run estimation of a bias and scale factor error model is not practical. In one embodiment, a simple error model based on calibration testing of the radios may be applied but this is likely only a typical scale factor correction and the bias used in the model would be set to zero. Thus, the measurement may used by the estimation filter but with appropriate associated measurement variance. The system 150 still benefits from the tight coupling of the UWB and GNSS measurements. The virtual position of the UWB reference station 155 is then recorded as the position determined by the RTK system (tightly-coupled or simply GNSS-only RTK for the first point). The estimated accuracy of the UWB reference station 155 is also recorded. The GNSS receiver 110 and system are then moved and the antenna is mounted over the next UWB reference station 160 with the second best GNSS satellite visibility conditions. The UWB ranges between the first UWB reference station 155 and perhaps some previously surveyed UWB reference stations 160 are used with GNSS measurements in a tightly coupled RTK solution to establish the virtual position and estimated accuracy of the second virtual UWB reference station. Although these steps are presented in a particular order for illustrative purposes, the present system and methods are not intended to be limited to this order. Rather, this description is offered as a non-limiting example of one method for determining virtual position measurements. This concept is illustrated in FIG. 1B. Again, the UWB range measurements are biased but still used with appropriate measurement variance by the estimation filter. The virtual positions and estimated accuracies of the remaining UWB reference stations (not shown) are determined using this method of moving the GNSS antenna and utilizing UWB reference stations that are already set up.

The virtual positions of the UWB reference stations 155, 160 and the associated measurement variance are recorded by the survey system 150 during deployment. The estimated uncertainty in the UWB reference positions may be accounted for by additional UWB range measurement variance when the UWB range is used in the estimation filter. Some UWB ranges may be from accurate locations (i.e. within a centimeter) and some ranges may be from rough locations (i.e. metre level). Both types of observations may still benefit the tightly-coupled solution.

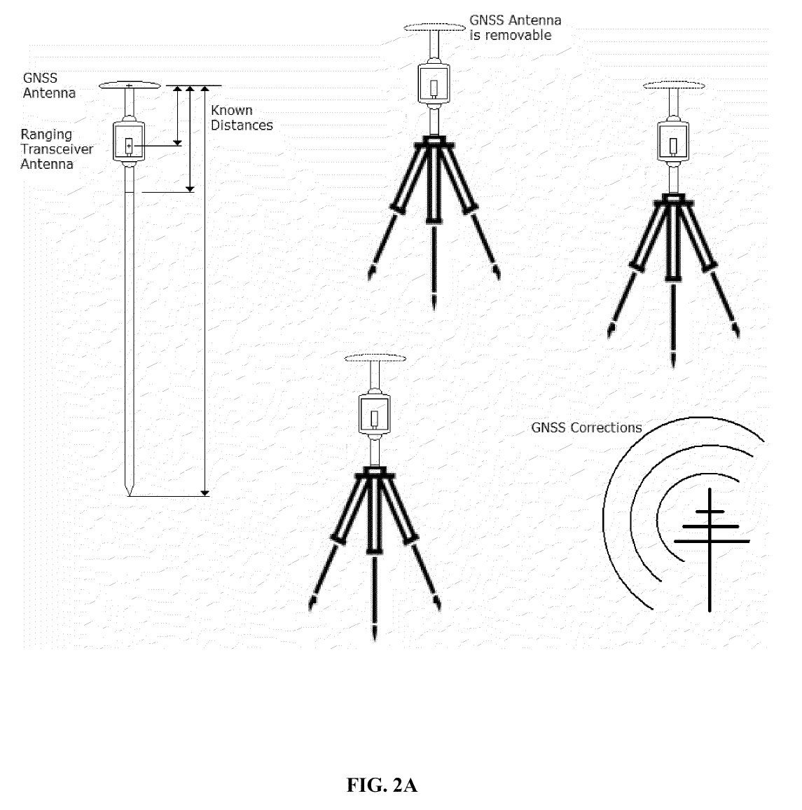

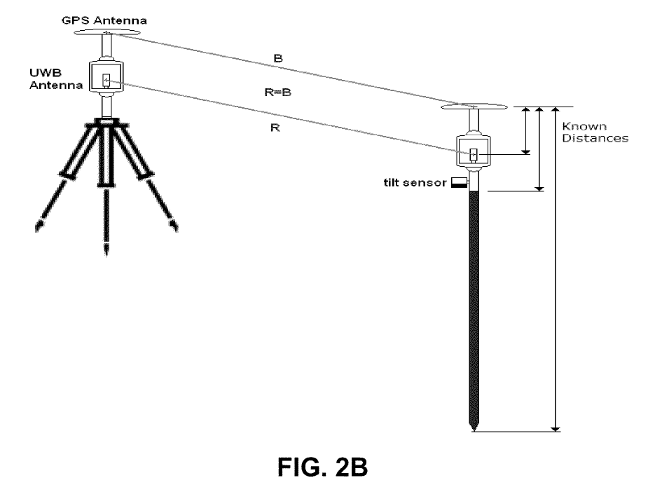

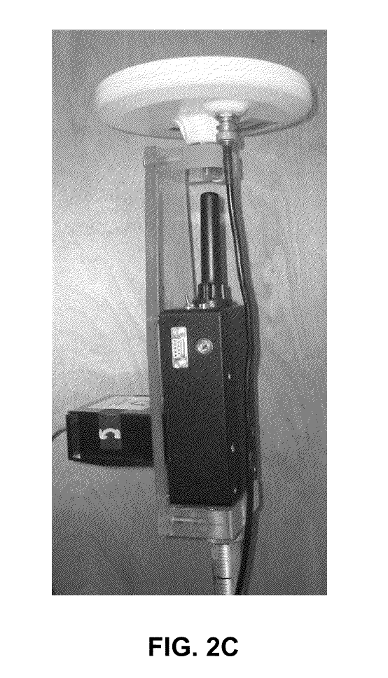

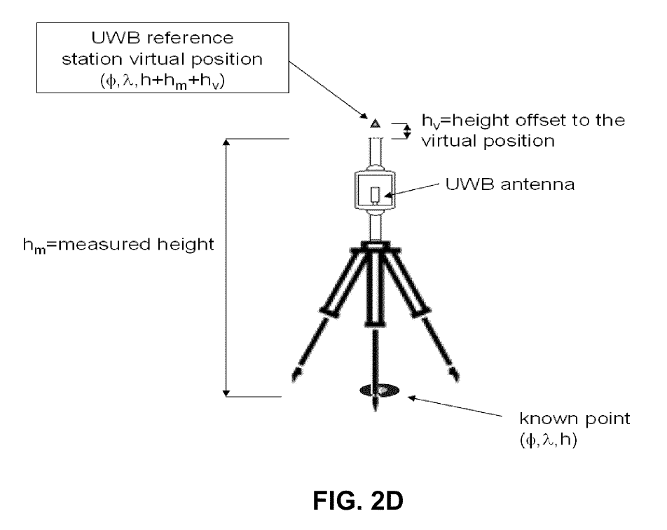

As depicted in FIGS. 1A and 2A, the UWB transceivers 115 may be mounted on tripods (or poles) and used as reference ranging transceivers. These transceivers may be placed at various locations around the surveyed area 105 within line-of-sight to four or more GNSS satellites 120. One or more GNSS receiver 110 may be used to determine the location of the reference ranging transceivers. In one example embodiment, each tripod-mounted reference ranging transceiver may be provided with a GNSS receiver to determine location thereof. In another example embodiment, a single GNSS receiver may be alternately used at each reference transceiver. Thus, once the position of the ranging transceiver is determined, the GNSS receiver can be removed and used again with another reference transceiver. In one example embodiment, the GNSS receiver may be placed on the survey tripod or pole, so that the phase center of the GNSS antenna is located, with a certain precision, a fixed distance above the phase center of the UWB transceiver antenna when both are vertically aligned to the local gravity vector. In further use of the GNSS antenna to position additional ranging transceivers, the same height difference between antenna phase centers is used. This improves the ability to estimate the final position solution when GNSS RTK and UWB ranging measurements are subsequently combined by removing the requirement to directly measure the height difference between the two antenna phase centers.

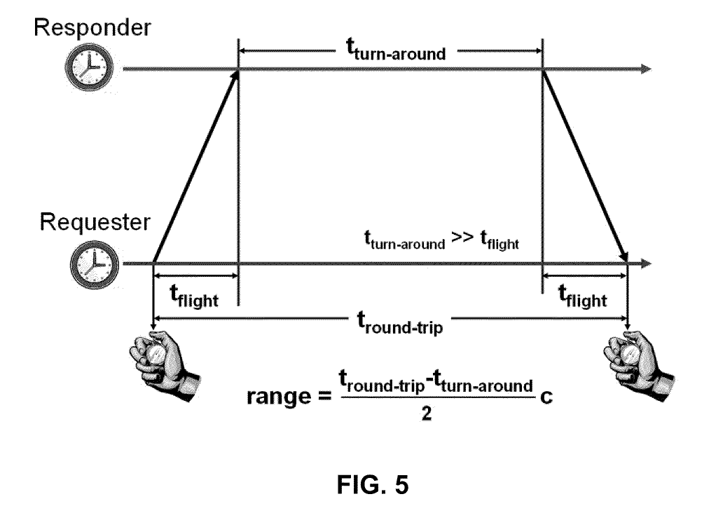

In one example embodiment, one of the ranging transceivers 130 may he mounted on the movable survey pole, tripod, vehicle, or any other suitable mounting apparatus, and will be used for surveying portions of area 105, which have poor or no satellite signal reception. The already deployed reference ranging transceivers 115 provide range measurements to each other and to the survey receiver 130 thereby trilaterating position of the survey receiver 130 with high precision. Typically, ranging observations cannot be produced directly from time-of-arrival (TOA) measurements unless both the transmitter and receiver are synchronized in time, which may not generally be the case. Accordingly, an asynchronous ranging based on time-of-flight measurements may be used in accordance with one example embodiment. In asynchronous ranging, the requester device uses knowledge of its own clock and a known turn-around-time to measure a two-way range as illustrated in FIG. 5. The requester, Device A, sends a ranging request, an encoded series of pulses, to the responder, Device B. The responder is able to synchronize to the incoming pulse train from Device A and generate ranging response, a series of encoded return pulses. One of the return pulses corresponds to a ranging pulse which has a fixed turn-around-time, t_{reply}. The requester detects the return pulse from the response pulse train and determines the one-way time-of-flight by the equation: tₚ=(t_{round}−t_{reply})/2, where tₚ is the time-of-flight, and t_{round} is the total time measured by the requester for the two-way round trip measurement. More information about asynchronous ranging method and associated measurement error effects may be found in the IEEE 802.15.4a specification, Appendix D1.3, (IEEE-802.15.4a, 2007). In other embodiments, synchronous ranging or other ranging techniques may be used.

In one example embodiment, the GNSS measurements, including accumulated Doppler range, Doppler, pseudorange, and carrier to noise density ratio measurements, may be combined with GNSS corrections and UWB ranging measurements using methods known to those of ordinary skill in the art to estimate the position of the surveying transceiver 130, and, in particular, the position of the ground point just below the contact end of the movable survey pole. However, centimeter and millimeter level positioning accuracies are more difficult to achieve without adding bias and scale factor states for each UWB range pair to the overall navigation estimation process. These are dominant sources of ranging error but they can be estimated as additional states in the navigation estimation process. In one example embodiment, the bias and scale factor errors may be estimated continually during deployment and survey stages of the ranging transceivers 115, 130. One-time calibration of these errors may be used in alternative embodiments, but such a method may not be suitable because scale factor error due to the technique used for detecting the leading-edge of an UWB pulse may not be stable.

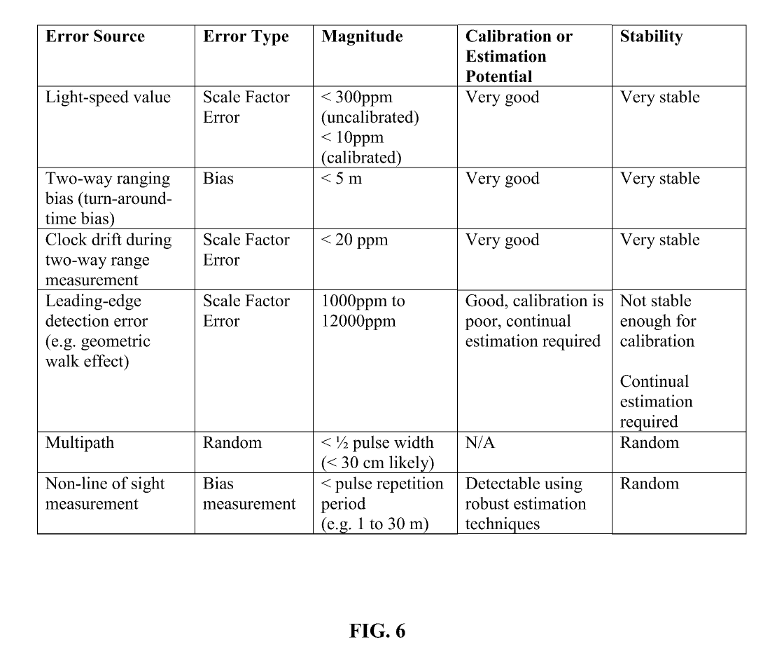

More specifically, impulse UWB ranging measurements based on the two-way time of flight technique have a number of error sources. Many of these errors are stable enough for a one-time calibration prior to performing a survey such as calibrating the value used for light-speed, the turn-around time bias, and the clock drift error (scale factor). A dominant error source in impulse UWB ranging is due to the method used for detecting and estimating the leading edge of the received pulse. Depending on the method used, the error may vary with respect to the distance measured (scale factor error) and can range from 1000 ppm to 12000 ppm. This error source can easily vary each time a device is turned on and hence is not suitable for one-time calibration. However, it is possible to estimate this scale factor error as an additional unknown in a navigation estimation process. Multipath acts as a random error source but is limited in magnitude to less than half the width of the pulse used (e.g. for a lns pulse, this error is less than 15 cm). There is potential for the ranging radios to fail to measure the line-of-sight response and produce a very biased measurement based on a non-line-of-sight path. These biased measurements are detectable using measurement testing techniques in the navigation estimation process. The table in FIG. 6 summarizes UWB ranging errors in terms of magnitude, stability, and ability to estimate or calibrate the error values.

In one embodiment, the UWB transceivers 115 may be integrated with the GNSS receiver 110. For example, co-axial GNSS/UWB antenna mounts may be built (one type for each UWB radio type may be used). The mount may be adapted such that the phase centers of the GNSS receiver 110 and the UWB antenna 115 are substantially vertically co-linear. A UWB range measurement is made between a reference UWB transceiver 115 and an UWB transceiver 115 on the survey system (e.g. pole mounted). In one example embodiment, the UWB range measurement may be used to estimate the phase center of the GNSS antenna 110 without having to deal with any lever arm offsets between the UWB antenna 115 and the GNSS antenna 110 (on both the reference and survey systems).

For example, a single GNSS baseline survey, with one GNSS antenna 110 mounted on a tripod over a known location and the other GNSS antenna mounted 110 on a survey pole. By mounting the reference UWB transceiver 115 and the survey system UWB transceiver 115 a fixed distance below the GNSS antennas 110, the UWB range measurement is equivalent to the GNSS baseline. This is illustrated in FIG. 2B.

When the UWB reference station 155, 160 is surveyed (using any method) so that a point above the reference UWB antenna is established and corresponds to the phase center of the real (or virtual) GNSS antenna 110, the UWB range measurements can be translated to estimate the GNSS antenna 110 phase center on the survey system. Thus, the UWB reference 115 station can be surveyed using GNSS RTK (as in FIG. 1) or if the UWB reference station 155, 160 is located over a known point the virtual point above the reference UWB antenna 115 is surveyed.

In one embodiment, the phase center of the UWB antenna may be aligned vertically above a threaded countersink (e.g. ⅝th inch) and below a threaded mounting bolt (e.g. ⅝th inch). This allows the mount to be placed on top of a standard surveying tribrach with a puck (with a threaded mounting bolt) or on a survey range pole and allows a GNSS antenna to be placed above the UWB radio antenna. The mount used with the Multispectral Solutions UWB radio is shown in FIG. 2C.

In one embodiment, a tilt sensor (also called an inclinometer) allows the lever arm between the GNSS antenna 110 and the UWB antenna 115 to be monitored in real time. Electrolytic or accelerometer based tilt sensors can be used for this purpose. Given that 2° of tilt only corresponds to about 4 mm of ranging error for a 12 cm lever arm, this sensor need not be high accuracy (i.e. a 2° precision instrument is sufficient). The sensor may be mounted beside the UWB radio 115, on the range pole, or even on the GNSS antenna 110.

In one embodiment, the method may depend upon the phase center of the UWB antenna 115 and the phase center of the survey system GNSS antenna 110 being aligned substantially co-linearly to the local gravity vector (i.e. plumb). If the system is not level, a lever arm may be introduced. A tilt sensor with an accuracy of about 3° (obtained via the RMS tilt value for 20 minutes of static data when measuring a tilt of 0°) may be used to monitor this lever arm. For example, one embodiment of a tilt sensor includes model EZ-TILT-1000-008 made by Advanced Orientation Systems Inc. The estimated standard deviation of the UWB measurement, as used by an estimation filter, may be increased based on the tilt angle to de-weight observations. For example, the approximate lever arm between the GNSS antenna 110 and the UWB antenna 115 may be 10 to 12 cm in testing with two UWB radio types. At a tilt of 20°, this may add approximately 4 cm of measurement bias. Monitoring the tilt may be important when the user is moving. For example, the bias may vary with the pole motion while moving and is typically correlated for about 1-5 seconds. The effect induced by the level arm effect is relatively small and thus, while not optimal, it is reasonable to just increase the measurement noise for the UWB range measurements. When the user is stationary over a point, a bubble level attached to the pole may be used to manually level the system and the error effect of the lever arm closely approximates white noise.

In one embodiment, the UWB reference stations 155, 160 may be deployed according to the following method. First, the deployment of the reference stations 155, 160 may proceed after identifying the area to be surveyed. The selection of the reference station locations may depend on obtaining: advantageous line of sight UWB range measurements (i.e. minimal obstructions), and the advantageous geometry for improving the solution (by trying to enclose a large volume with the UWB reference stations to obtain the best DOP).

In one embodiment, the UWB reference stations 155, 160 may be deployed at similar heights. This means that the UWB measurements may not contribute very much to the estimation of the height parameter (i.e. do not improve VDOP) but they do significantly improve HDOP. To obtain better VDOP and hence contribute more to the height solution, the UWB reference stations 155, 160 may be placed with significant height differences.

For UWB reference stations 155 that are to be placed over previously surveyed coordinates, the UWB radio 115 may be set up (usually with a tripod and tribrach) using the UWB radio mount and the height to the base of the threaded bolt on the top of the mount may be recorded. The GNSS antenna 110 that will be used for the survey may have a known phase center. The distance from the bottom of the threaded countersink of the antenna to this phase center may be known. The virtual coordinates of the UWB reference station antenna 155 may be entered as the coordinates of the known point plus the height already recorded plus the GNSS antenna phase center height. The UWB reference station antenna position is considered a virtual position because it pertains to a virtual point above the phase center of the actual UWB antenna. This concept is illustrated in FIG. 2D. A UWB range measurement between this reference station 155 and another UWB radio mounted on an identical mount may be equivalent to a range measurement between the virtual UWB antenna position and the phase center of the GNSS antenna on the survey system (provided both the reference station and the survey system are aligned to the local gravity vector (i.e. plumb)).

The UWB Ranging Error Budget

Light Speed Value: The first velocity correction, which corrects for the light speed value used by the receiver based on temperature pressure and water vapor pressure, can be as much as 300 ppm compared to light speed in a vacuum.

Two-way ranging: For two-way time-of-flight ranging, there is a potentially large associated bias term due to oscillator drift errors during the fixed length of time a responder ranging transceiver waits before replying to a requester ranging transceiver, referred to as turn-around-time bias. There is also a much smaller scale factor error due to oscillator drift in the requester receiver during time-of-flight.

Multipath: If the line-of-sight signal is detected, multipath induced error should not be more than ½ the pulse width.

NLOS: Non-line of sight transmission means that signals are potentially attenuated, reflected and refracted. If the line-of-sight signal is not detected, the maximum error can be large as the first strongest multipath will be used. This is likely a meter level effect for UWB systems capable of centimeter level precision.

Peak Estimation/Leading Edge Detection: The method used to estimate the fine time delay of a pulse can contribute to range error such as the geometric ‘walk’ with threshold energy detection. Clock jitter will affect the accuracy of correlation techniques and sampling rate will affect the ability to correlate as well.

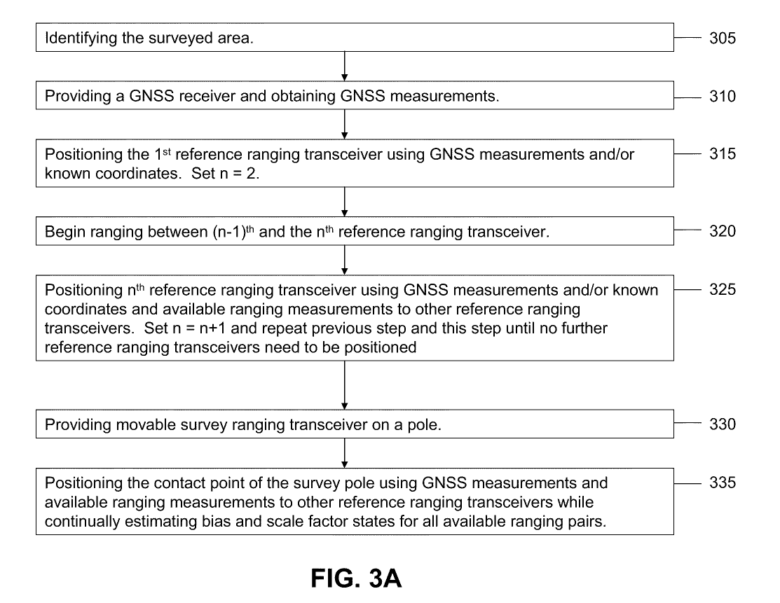

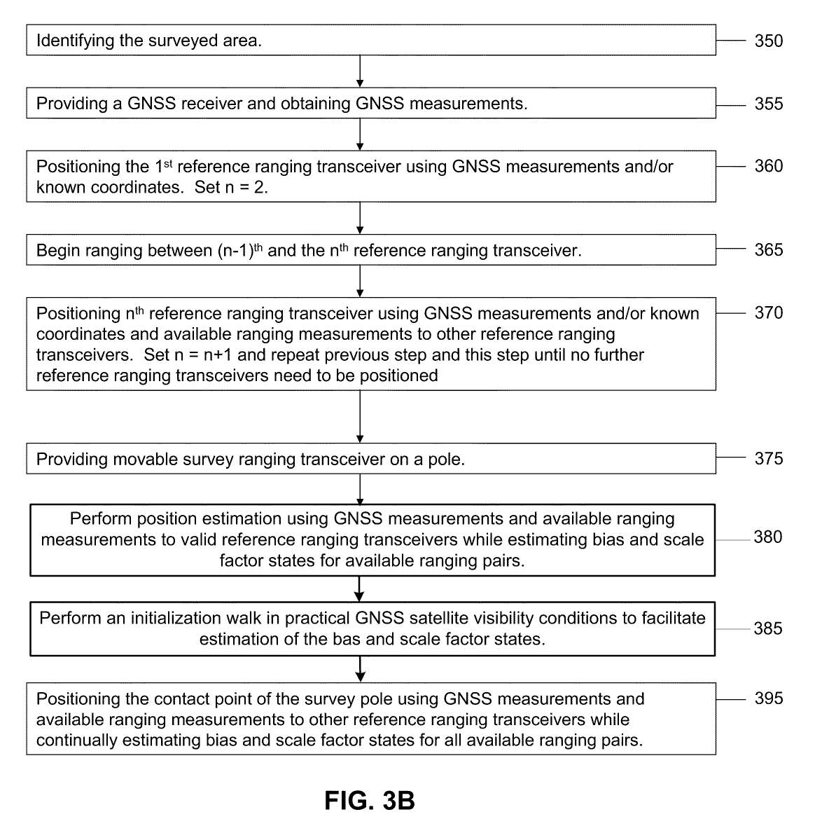

In one example embodiment, GNSS RTK surveying system augmented with UWB radios may be used to provide positioning information in urban canyons, forests, congested construction sites and other hostile environments where GNSS signal may not be available due to signal masking, attenuation, multipath and other signal propagation impairments. FIG. 3A illustrates one embodiment of such a surveying process. Process 300 begins at operation 305 in which the surveyed area is identified. At operation 310, one or more reference ranging receivers, such as UWB ranging radios, are placed in the locations surrounding the identified surveyed area where satellite signals are detected. At operation 315, a GNSS receiver may be mounted on top of the first available reference ranging receiver, aligned with the local gravity vector and used to determine the position of the reference ranging receiver using GNSS measurements which may include accumulated Doppler range, Doppler, pseudorange, and carrier to noise density ratio measurements. Alternatively, if the reference ranging receiver 155 is located at a known point, the coordinates of that known point may be used. In certain embodiments, GNSS measurements may be used for a first ranging receiver 160 and known coordinates may be used for a second ranging receiver 115. At operation 320, the ranging radio begins ranging with the next available ranging transceiver. At operation 325, the position of the next available ranging transceiver is determined by mounting the GNSS receiver on top of the ranging receiver 155, 160 and/or by obtaining known coordinates for the ranging receiver 155, 160, after alignment to the local gravity vector, using available ranging measurements to other reference ranging transceivers and GNSS measurements such as accumulated Doppler range, Doppler, pseudorange, and carrier to noise density ratio measurements. Operations 320 and 325 are repeated until all reference ranging transceivers are positioned. At operation 330, a movable surveying pole with a ranging transceiver is placed in the surveyed area where there is limited or no GNSS signals. At operation 335, the position of the contact point of the survey pole is estimated using GNSS measurements and available ranging measurements while all bias and scale factor states for all available ranging pairs are continually estimated.

FIG. 3B illustrates a further embodiment of the survey process. In certain embodiments, this process may include the operations described above with relation to FIG. 3A. In addition, at operation 380, may include performing position estimation using GNSS measurements and available ranging measurements to valid reference ranging transceivers while estimating bias and scale factor states for available ranging pairs. At operation 385 the method of 3B may also include performing an initialization walk in practical GNSS satellite visibility conditions to facilitate estimation of the bias and scale factor states.

For example, the initialization walk may be used to model the UWB range measurement errors using a bias and a scale factor state. In one embodiment, the non-linear UWB range measurement model may be:

R=κρ+β+ε

ρ=\sqrt{(xᵤ−x)²+(yᵤ−y)²+(zᵤ−z)²}

where R is the UWB range measurement, κ is a scale factor, β is a bias, ε is measurement noise, ρ is the geometric range between the UWB reference station antenna, located at the earth centered earth fixed coordinates (ECEF) xu, yu, and zu, and the survey system UWB antenna, located at the ECEF coordinates x, y, and z.

The bias and scale factor estimates may be relatively stable during a survey. For example, the high positioning accuracy of GNSS RTK (e.g. 2 cm) under nominal conditions may be used to facilitate the estimation of the UWB bias and scale factor states. Once these states are well estimated, the corrected UWB range measurements may enable and extend RTK accuracy into conditions that are hostile to GNSS alone. In order to estimate the bias and scale factor states, an initialization walk with sufficient range of motion (at least as great as the extent of the survey area) is required under nominal GNSS RTK conditions.

Each UWB range pair may have a separate bias and scale factor state. These states are included in the tightly-coupled estimation process. For example, if there are three UWB reference stations and once survey system UWB system, then there are three bias states and three scale factor states (one for each UWB range pair) included in the estimation filter.

The bias states may change over time because they are a function of the oscillator stability of the UWB radios. These oscillators may exhibit frequency bias as a function of temperature and thus a few minutes of initialization time prior to UWB radio use to let the internal temperature of the radio stabilize is a good idea. The scale factor state may change if the radio is powered off and on. For example, this occurs for the Multispectral Solutions UWB radios because they use a constant threshold fine timing discriminator. This threshold is set once based on internal noise when the radio is turned on. Thus, cycling the unit's power will change the scale factor state. This is undesirable so the power on the UWB radios should be kept on during deployment, the initialization walk and during the survey.

Once the initialization walk 390 is completed, the survey system may be taken into the survey area 105. The system may then perform 395 position estimation. For example, points may be occupied until the estimated accuracy of the solution is suitable. In other words, standard RTK surveying techniques are employed in the survey area.

Some of the position estimation operations may be performed by hardware components or may be embodied in machine-executable instructions, which may be used to cause a general-purpose or special-purpose processor or logic circuits programmed with the instructions to perform the operations. Alternatively, the operations may be performed by a combination of hardware and software. Embodiments of the invention may be provided as a computer program product that may include a machine-readable medium having stored thereon instructions, which may be used to program a computer (or other electronic devices) to perform a process according to the invention. The machine-readable medium may include, but is not limited to, optical disks, CD-ROMs, and magneto-optical disks, ROMs, RAMs, EPROMs, EEPROMs, magnetic or optical cards, flash memory, or other type of media/machine-readable medium suitable for storing electronic instructions.

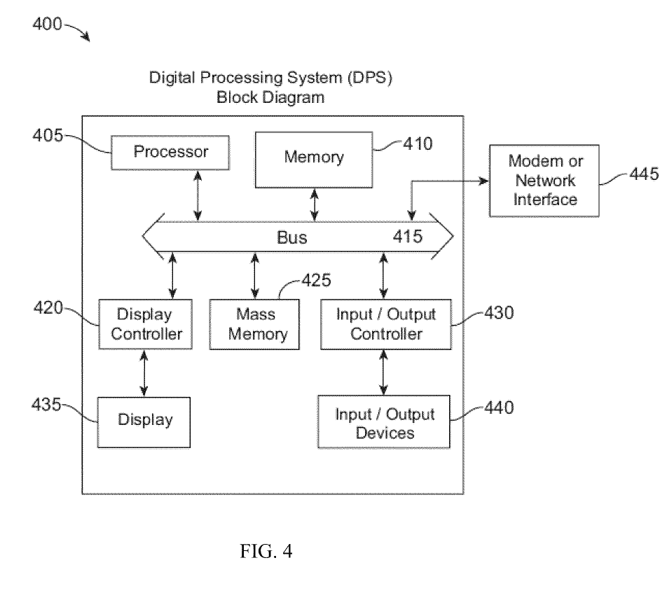

Embodiments of the invention may employ digital processing systems (DPS), such as a personal computer, a notebook computer or other devices having digital processing capabilities to perform position estimation and error corrections. Such DPSs may be a processor and memory or may be part of a more complex system having additional functionality. FIG. 4 illustrates a functional block diagram of a digital processing system that may be used in accordance with one example embodiment. The processing system 400 may be used to perform one or more functions of a communications signal receiver system in accordance with an embodiment of the invention. The processing system 400 may be interfaced to external systems, such as GNSS receivers and UWB ranging radios through a network interface 445 or serial or parallel data interface. The network interface or modem may be an analog modem, an ISDN modem, a cable modem, a token ring interface, a satellite transmission interface, a wireless interface, or other interface(s) for providing a data communication link between two or more processing systems. The processing system 400 includes a processor 405, which may represent one or more processors and may include one or more conventional types of processors, such as Motorola PowerPC processor or Intel Pentium processor, etc.

A memory 410 is coupled to the processor 405 by a bus 415. The memory 410 may be a dynamic random access memory (DRAM) and/or may include static RAM (SRAM). The system may also include mass memory 425, which may represent a magnetic, optical, magneto-optical, tape, and/or other type of machine-readable medium/device for storing information. For example, the mass memory 425 may represent a hard disk, a read-only or writeable optical CD, etc. The mass memory 425 (and/or the memory 410) may store data that may be processed according to the present invention. For example, the mass memory 425 may contain a database storing previously determined position estimates error lookup tables, position estimate algorithms and other data and computer programs.

The bus 415 further couples the processor 405 to a display controller 420, a mass memory 425 (e.g. a hard disk or other storage which stores all or part of the DR algorithms). The network interface or modem 445, and an input/output (I/O) controller 430. The display controller 420 controls, in a conventional manner, a display 435, which may represent a cathode ray tube (CRT) display, a liquid crystal display (LCD), a plasma display, or other type of display device. The I/O controller 430 controls I/O device(s) 440, which may include one or more keyboards, mouse/track ball or other pointing devices, magnetic and/or optical disk drives, printers, scanners, digital cameras, microphones, etc.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method for surveying, the method comprising:
identifying an area to be surveyed;
placing one or more reference ranging transceivers in one or more locations proximate to the identified survey area where GNSS signals are detected;
measuring the position of at least one of said reference ranging transceivers with a GNSS receiver;
providing a survey ranging transceiver in the survey area, said survey ranging transceiver configured to conduct ranging measurements;
conducting ranging measurements between said survey ranging transceiver and at least one of said reference transceivers; and
combining GNSS measurements and ranging measurements to estimate the position of the surveying ranging transceiver.

2. The method claim 1 further comprising:
placing one or more reference ranging transceivers in one or more known locations proximate to the identified survey area;
providing coordinates of the known position of at least one of said reference ranging transceivers;
providing a survey ranging transceiver in the survey area, said survey ranging transceiver configured to conduct ranging measurements;
conducting ranging measurements between said survey ranging transceiver and at least one of said reference transceivers; and
combining the known coordinates and ranging measurements to estimate the position of the surveying ranging transceiver.

3. The method of claim 1 further comprising computing bias and scale factor states for each reference ranging transceiver pair to improve said estimate of position of the surveying ranging transceiver.

4. The method of claim 1 further comprising measuring the position of at least one of said reference ranging transceivers using ranging data from one or more other available reference ranging transceivers.

5. The method of claim 2 wherein said survey ranging receiver is configured to function in an area with limited GNSS signal reception.

6. The method of claim 1, wherein the GNSS receiver is removably mounted on top of said ranging transceiver.

7. The method of claim 6, wherein the GNSS antenna's phase center is located a predetermined distance above the phase center of a ground-based ranging transceiver antenna of said reference ranging transceivers when the vector between the phase center of the GNSS antenna and the ranging transceiver antenna is vertically aligned, within a certain precision, to the local gravity vector.

8. The method of claim 1, wherein the GNSS receiver is operable to collect GNSS measurements including at least one of accumulated Doppler range, Doppler, pseudorange, and carrier to noise density ratio measurements.

9. A method of determining the position of the ground point, said method comprising:
gathering GNSS measurements and ground-based ranging transceiver measurements for a plurality of reference transceivers using a vertical mounted GNSS antenna and a ranging transceiver antenna;
estimating bias and scale factor error states for one or more ground-based ranging transceiver pairs; and
determining the position of the ground point using said measurements and said bias and scale factor estimates.

10. The method of claim 9, wherein the phase center of the GNSS antenna is mounted, with a certain precision, a fixed distance above the phase center of the ranging transceiver antenna.

11. The method of claim 9, wherein measurements are deemed valid when the vertical mounted GNSS antenna and ranging transceiver antenna is vertically aligned to the local gravity vector within a certain precision.

12. The method of claim 9, wherein a digital tilt meter which is mounted on the side of said GNSS antenna, is used to assess the validity of the ground-based ranging measurements.

13. The method of claim 9, wherein the phase center of the ranging transceiver antenna and the GNSS antenna is located, with a certain precision, a known distance above a ground contact point of a pole configured to include said ranging transceiver antenna and said GNSS antenna.

14. The method of claim 9, wherein GNSS measurement corrections can be communicated to the processor using the communications channel of the ground-based ranging transceivers.

15. The method of claim 9, wherein indirect ground-based ranging measurements between transceivers can be communicated to the processor using the communications channel of the ground-based ranging transceivers.

16. A survey apparatus comprising:
a survey pole or tripod having at least one contact end for placing on a ground point,
a ranging transceiver mounted on the survey pole or tripod for receiving ranging signals from one or more reference ranging transceivers, and
a GNSS receiver removably mounted on the survey pole or tripod, above the ranging transceiver antenna, for receiving GNSS signals.

17. The apparatus of claim 16, wherein the GNSS receiver is operable to receive one or more of the GPS, GLONASS and Gallileo satellite positioning signals.

18. The apparatus of claim 16, wherein the GNSS receiver collects GNSS measurements including one or more of accumulated Doppler range, Doppler, pseudorange, and carrier to noise density ratio measurements.

19. The apparatus of claim 16, wherein the ranging transceiver includes a UWB radio.

20. The apparatus of claim 16, wherein a phase center of the GNSS receiver antenna is located a predetermined distance above the phase center of ranging transceiver antenna when the vector between the phase center of the GNSS receiver antenna and the ranging transceiver antenna is vertically aligned, within a certain precision, to the local gravity vector.

21. The apparatus of claim 16, wherein the phase center of the ranging transceiver antenna is located, with a certain precision, a predetermined distance above the contact ends of the survey pole or tripod.

22. The apparatus of claim 16 further comprising a processor operable to collect GNSS measurements and ground-based ranging transceiver measurements to determine bias and scale factor error states for one or more ground-based ranging transceiver pairs and to determine the position of the ground point below the contact end of the survey pole or tripod using said determined bias and scale factor parameters.
